(19) United States
(12) Patent Application Publication
(10) Pub. No.: US 2026/0104916 A1
(43) Pub. Date: Apr. 16, 2026

(54) ACCELERATED REMOTE DIRECT MEMORY ACCESS (RDMA) COMMAND CONSTRUCTION FOR GRAPHIC PROCESSING UNIT (GPU) DIRECTED FINE-GRAINED COMMUNICATION

(71) Applicants: Advanced Micro Devices, Inc., Santa Clara, CA (US); XILINX, INC., San Jose, CA (US)

(72) Inventors: Lucian PETRICA, Dublin (IE); Kenneth O'BRIEN, Dublin (IE); Brandon K. POTTER, Austin, TX (US); Tobias Alonso PUGLIESE, Dublin (IE)

(21) Appl. No.: 18/915,201

(22) Filed: Oct. 14, 2024

(51) Int. Cl. G06F 9/48; G06F 15/173

(52) U.S. Cl. CPC G06F 9/4881; G06F 15/17331

(57) ABSTRACT

Accelerated remote-direct-memory-access (RDMA) command construction for GPU-directed fine-grained communication, including interpreter logic that frees a host device and/or compute units of a data processing element (DPE), such as graphic processing unit (GPU), from managing execution of the WRs. The interpreter logic frees the host/DPE from managing execution of the WRs. The interpreter logic may access memory of the host/DPE (e.g., data, work request queues, completion queues, etc.), such as to retrieve the WRs and/or to write completion notifications, and/or the host/DPE may write the WRs to registers accessible to the interpreter logic.

### TECHNICAL FIELD

Examples of the present disclosure generally relate to accelerated remote direct memory access (RDMA) command construction for graphic processing unit (GPU) directed fine-grained communication.

### BACKGROUND

For high computational efficiency in distributed applications, it is desirable to enable compute units of a graphics processing unit (GPU) to perform fine-grained accesses to remote memory, which allows fine-grained interleaving of computation and communication during application execution. In practice, overhead processes associated with orchestrating network transfers from the GPU may eliminate the advantages fine-grained accesses.

### SUMMARY

Techniques for accelerated remote-direct-memory-access (RDMA) command construction for GPU-directed fine-grained communication are described.

One example is a system that includes interpreter logic that receives work requests (WRs) from a compute unit (CU), converts the WRs to remote direct memory access (RDMA) work request elements (WQEs), and provides the WQEs to an RDMA stack.

Another example is a data processing unit (DPU) that includes a host interface to receive RDMA WRs from a host device, an interpreter accelerator that converts the WRs to WQEs and provides the WQEs to an RDMA stack, and network input/output (IO) circuitry that interfaces with a remote device over a packet-switched network, including to process the WQEs of the RDMA stack. The DPU may further include a packet buffer that stores packets received by the network IO circuitry, one or more programmable packet processing pipelines that process the packets of the packet buffer, memory, one or more processors that execute instructions stored in the memory, and interface circuitry coupled to the host interface, the network IO circuitry, the packet buffer, the packet processing pipeline, the memory, the processor, and the interpreter accelerator.

Another example is a method that includes receiving work requests (WRs) from a compute unit (CU), converting the WRs to remote direct memory access (RDMA) work request elements (WQEs), and providing the WQEs to an RDMA stack, by interpreter logic. The method may further include receiving intermediate completion notices and final completion notices related to the WQEs, providing the final completion notices to the CU, and withholding the intermediate completion notices from the CU.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts a system that includes interpreter logic, according to an embodiment.

FIG. 2 depicts operations of the system of FIG. 1, according to an embodiment.

FIG. 3 depicts a system that includes features of the system of FIG. 1, in which the interpreter logic is provided within a data processing element (DPE), according to an embodiment.

FIG. 4 depicts a method of interpreting work requests within a DPE, according to an embodiment.

FIG. 5 depicts a system that includes features of the system of FIG. 1, in which the interpreter logic is provided within a network interface controller (NIC), according to an embodiment.

FIG. 6 depicts the system of FIG. 5 in a work queue (WQ) access configuration, according to an embodiment.

FIG. 7 depicts a WQ-access based method of interpreting work requests within a network interface controller (NIC), according to an embodiment.

FIG. 8 depicts the system of FIG. 5 in a memory-mapped input/output (MMIO) configuration, according to an embodiment.

FIG. 9 depicts a MMIO-based method of interpreting work requests within a network interface controller (NIC), according to an embodiment.

FIG. 10 depicts interpreter logic, according to an embodiment.

FIG. 11 depicts an integrated circuit device that includes a data processing unit (DPU), according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe accelerated remote-direct-memory-access (RDMA) command construction for GPU-directed fine-grained communication.

For high computational efficiency in distributed applications, it is desirable to enable compute units (CUs) of a graphics processing unit (GPU) to perform fine-grained accesses to remote memory (i.e., individual accesses for relatively small blocks of data), which allows fine-grained interleaving of computation and communication during application execution, and which may maximize use of available network bandwidth. Interleaving is beneficial because a scheduler of the GPU may mask communication latencies by scheduling other unrelated work on the CUs while RDMA commands execute, without requiring an application developer to explicitly implement overlap between communications and computations.

It would be useful to achieve both higher programmer productivity and increased program efficiency. However, the fine-grained approach results in communication being fragmented in many small RDMA accesses, which are challenging in several ways. As an example, latency overheads for initiating RDMA accesses are incurred for each RDMA work request (WR). Thus, executing numerous RDMA accesses of relatively small blocks of data may incur more latency than executing fewer RDMA accesses of relatively large blocks of data. As another example, numerous numbers of small RDMA may need to be issued simultaneously to saturate the network bandwidth. In order to do so, the system (e.g., a host central processing unit, the GPU, and a network interface controller) need to be able to effectively scale up to thousands of simultaneous RDMA accesses.

There are two broad approaches to communicating GPU-computed data, proxy thread and GPU-direct. For proxy thread approaches, a CPU thread manages communication and interacts with the GPU kernels through normal host-GPU channels. An advantage of a proxy thread approach is that the CPU is very effective at creating and managing NIC work with low latency overheads. A disadvantage is that the proxy thread is a bottleneck for fine-grained communication, where thousands of GPU threads may initiate communication, nearly simultaneously, and the requests are serialized at an interface to the proxy thread, which reduces achievable bandwidth for small data. Because of these characteristics, proxy thread approaches may be more suitable for relatively coarse-grained communication initiated from the GPU.

For GPU-direct approaches, GPU threads (i.e., CUs) construct RDMA work request elements (WQEs) and place them in send queues in GPU memory, and the GPU polls RDMA completions, also in in the GPU memory. An advantage to GPU-direct approaches is scalability. Threads can (with good approximation), independently construct WQEs and issue them to the NIC, resulting in a very scalable solution that can maximize the achievable network throughput when performing fine-grained communication with small data. A drawback with GPU-direct approaches is that GPU threads are not as effective as a CPU at generating WQEs and managing queues. As an example, a GPU thread may take approximately 5 us to construct a WQE, whereas CPU may construct the same WQE in under 1 us. As a result, overall latency of a GPU-to-GPU approach (e.g., a ping-pong operation) may be over two times greater a GPU-direct approach relative to a proxy thread approach.

Accelerated RDMA command construction for GPU-directed fine-grained communication, as disclosed herein, provides scalability without adding latency overhead. As disclosed herein, RDMA command generation (e.g., WQE generation), is offloaded to dedicated logic/accelerators (e.g., hard and/or configurable logic in GPU fabric or a smartNIC), referred to herein as interpreter logic. The interpreter logic converts high-level data movement commands (PUTs, GETs, SYNCs) into low-level RDMA commands such as READ, WRITE, and atomics, which are then handed over to the NIC without further CU intervention. In an example, a CU posts high-level data movement commands, referred to herein as work requests (WRs), to the interpreter logic. The CU may continue executing work unrelated to the data movement commands while the interpreter logic constructs and executes WQEs based on the data movement commands (e.g., as the interpreter logic constructs network packets, interacts with the NIC to transmit the packets and synchronize with remote GPUs via the network). Delegating the communications to the interpreter logic reduces register pressure on the CUs, and releases valuable CU compute cycles, which enables the CUs to perform other work while communication operations are ongoing. The interpreter logic is scalable, and improves utilization of network bandwidth, and reduces latency.

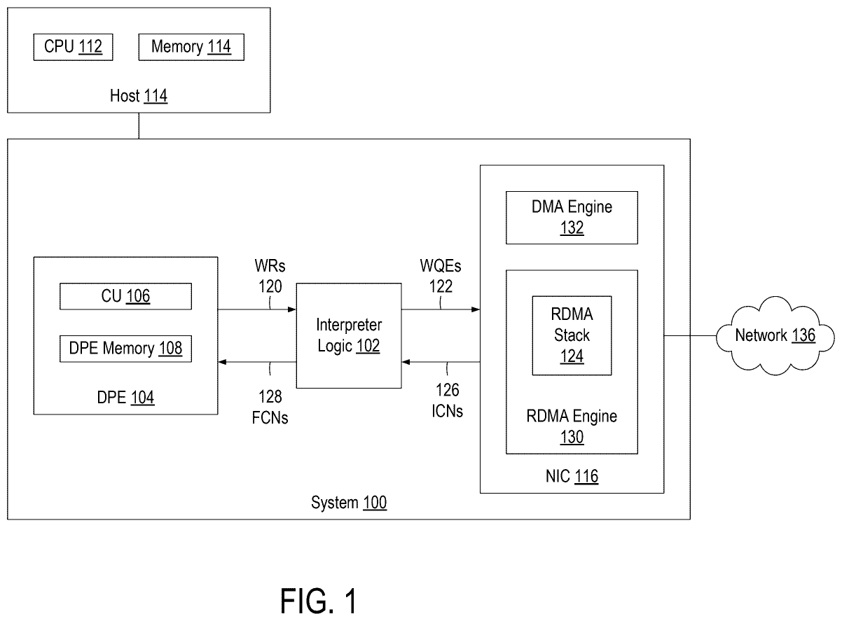

FIG. 1 depicts a system 100 that includes interpreter logic 102, according to an embodiment. System 100 further includes a data processing element (DPE) 104 that includes one or more compute units (CUs) 106, and DPE memory 108. DPE 104 may include or represent a graphics processing unit (GPU). DPE 104 is not, however, limited to a GPU. DPE memory 108 may include, for example and without limitation, high-bandwidth memory (HBM). System 100 may interface with a host 114, which may include a processor, depicted here as a central processing unit (CPU) 112, and memory 114. In this example, DPE 104 may serve as an accelerator for performing (i.e., for offloading) functions of an application program executing on CPU 112. System 100 further includes a network interface controller (NIC) 116 that interfaces between DPE 104 and a packet-switched network 136. NIC 116 may communicate (e.g., exchange data) with other devices (e.g., DPEs) via network 136. One or more of the other devices may include interpreter logic as disclosed in one or more examples herein.

In FIG. 1, interpreter logic 102 receives work requests (WRs) 120 from DPE 104, constructs work request elements (WQEs) 122 based on the WRs 120, and provides the WQEs 12 to a network stack (stack) 124 of NIC 116. WRs 120 may include higher-level transaction codes, which may be referred to as opcodes. WRs 120 may relate to data transfer operations (e.g., send/receive, read/write), and may include remote direct memory data access (RDMA) operations, collective operations (e.g., put, broadcast, scatter, gather, reduce, and/or barrier), atomic operations, and/or other operations. Where a WR relates to a data transfer operation, the WR may further include information indicating a location within DPE memory 108 for the data transfer operation (e.g., bit-length, start location/offset, and/or stop location/offset). WQEs 122 may include lower-level commands (e.g., RDMA commands) and signaling to implement WRs 120. A WR 120 may include relatively few fields (e.g., as few as 2 fields).

In the example of FIG. 1, stack 124 is depicted as a remote direct memory access (RDMA) stack of an RDMA engine 130. Stack 124 is not, however, limited to an RDMA stack. Host 114 may provide setup information to interpreter logic 102 and/or NIC 116. Host 114 may provide setup information to RDMA engine 130 to setup queue-pairs with remote systems. A queue-pair is a pair of buffers that are linked through respective RDMA engines for RDMA operations. NIC 116 may further include a direct memory access (DMA) engine 132 that accesses DPE memory 108, or a portion thereof, and/or memory of a remote device (i.e., via network 136).

Interpreter logic 102 may include hardened/fixed-function circuitry, configurable circuitry, programmable circuitry, a processor and memory, a micro-controller, and/or combinations thereof. The term “hardened circuitry” refers to fixed-function circuitry (i.e., circuitry that is neither programmable nor configurable). The term “configurable circuitry” refers to hardened circuitry having selectable options/features. The term “programmable circuitry” refers to programmable logic and programmable interconnects. The programmable logic may include, for example and without limitation, flip-flops, look-up tables (LUTs), and/or a processor and random-access memory (RAM) for storing instruction for execution by the processor. Programmable circuitry may also be referred to as programmable logic (PL) and/or programmable fabric. System 100 may include, for example and without limitation, a field-programmable gate array (FPGA) and/or an application-specific integrated circuit (ASIC), and interpreter logic 102, or a portion thereof, may be configured within programmable logic of the FPGA or ASIC. Interpreter logic 102 may include a state machine that parses and converts high-level WRs into lower level commands, and interacts with RDMA engine 130 to realize a sequence of the lower level commands.

Programmable logic RAM may be accessible to interpreter logic 102. Alternatively, or additionally, system 100 may include other/additional RAM that is accessible to interpreter logic 102, and/or interpreter logic 102 may include dedicated RAM. Interpreter logic 102 may use the RAM to translation tables and/or other information (e.g., pre-populated by CPU 112 and/or CU 106), and/or to store state information.

In an example, interpreter logic 102 is implemented in hardware (e.g., hardened circuitry and/or a FPGA/ASIC), such as by writing and synthesizing register transfer level (RTL) code (e.g., Verilog VHDL) to ASIC or FPGA, and/or or writing and synthesizing a C++ description of the interpreter with High-Level Synthesis tools such as Vitis HLS down to Verilog/VHDL, which can be subsequently synthesized to ASIC/FPGA gates/LUTs.

Where interpreter logic 102 is implemented in reconfigurable logic (e.g., FPGA fabric), interpreter logic 102 may be modified via dynamic partial reconfiguration. As an example, interpreter logic 102 may initially be configured for a first set of set of WRs that define a state machine(s), where the first set of WRs corresponds to a first programming model, such as a shared memory programming model, for use with a first application program. If the interpreter logic 102 is to be used for a second application program that is based on a different programming model, a different state machine(s) may be needed. In such a situation, interpreter logic 102 may be modified via dynamic partial reconfiguration to parse/convert WRs of the second application program.

In another example, interpreter logic 102 includes a microcontroller and custom instructions. In this example, interpreter logic 102 may be defined by in C code, for example, that specifies/defines how to convert WRs to WQEs. A definition of a WQE and/or a WQE template may be stored in memory of the microcontroller. The microcontroller may populate the WQE template with information from a WR. The microcontroller can be reconfigured by loading a parser program into the microcontroller to parse/convert a different set of high level commands (i.e., WR) into an existing set of low level commands (i.e., WQEs).

Interpreter logic 102 may be provided within DPE 104 and/or NIC 116, and/or external of DPE 104 and NIC 116, examples of which are provided further below.

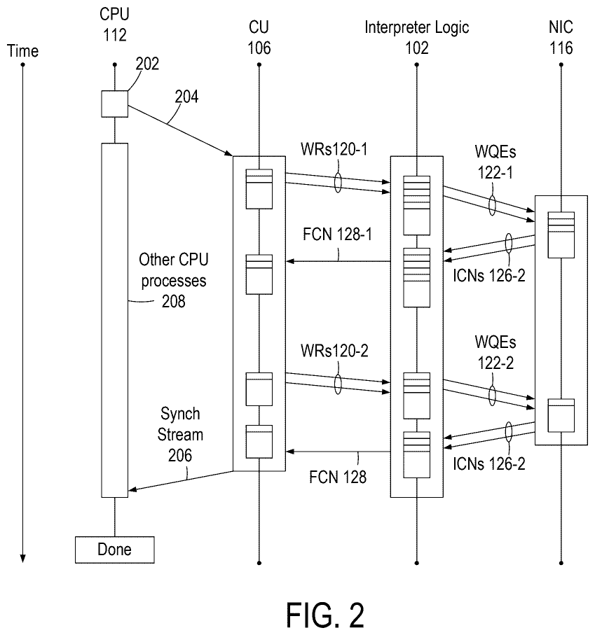

FIG. 2 depicts operations 200 of system 100, according to an embodiment. In the example of FIG. 2, a main thread 202 executing on CPU 112 launches an operation 204 (i.e., A_com_B) on a CU 106. While executing A_com_B, CU 106 posts WRs 120-1 and 120-2 to interpreter logic 102. Interpreter logic 102 constructs WQEs 122-1 and 122-2 based on WRs 120-1 and 120-2, and forwards WQEs 122-1 and 122-2 to NIC 116 (i.e., to stack 124). Interpreter logic 102 may construct multiple WQEs 122-1 based on WR 120-1, and/or may construct multiple WQEs 122-2 based on WR 120-2.

Interpreter logic 102 forwards WQEs 122-1 and 122-2 to NIC 116 (i.e., to stack 124). NIC 116 and interpreter logic 102 may communicate with one another as NIC executes WQEs 122-1 and 122-2. As NIC 116 executes WQEs 122-1 and 122-2, NIC 116 may issue respective intermediate completion notifications (ICNs) 126-1 and 126-2. Interpreter logic 102 may intercept and withhold ICNs 126 from CU 106. Upon completion of WQEs 122-1 and 122-2, interpreter logic 102 may provide respective final completion notifications (FNCs) 128-1 and 128-2 to CU 106. Upon completion of operation 204 (i.e., A_com_B), CU 106 reports to CPU main thread, depicted here as a synchronization stream 206.

In FIG. 2, interpreter logic 102 de-composes higher-level WRs to lower-level WQEs (e.g., RDMA commands). Lower-level operations are thus handled by interpreter logic 102, rather than by CPU 112 or CUs 106. CPU 112 and CUs 106 do not need to create WQEs entries for data transfers, or WQEs for signaling to remote nodes. CPU 112 and CUs 106 also do not need to monitor for intermediate steps or monitor execution ordering of the WQEs. Thus, CPU 112 may perform other processes 208 while CU 106 executes operation 204, and CU 106-6 may thus perform other functions of operation 204 while NIC 116 executes WQEs 122-1 and 122-2.

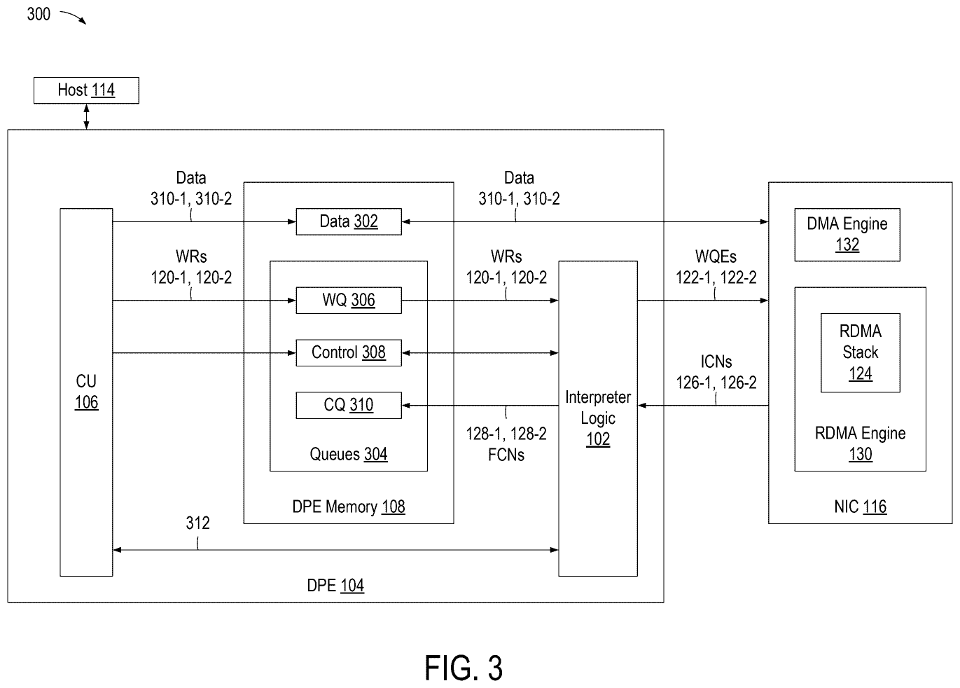

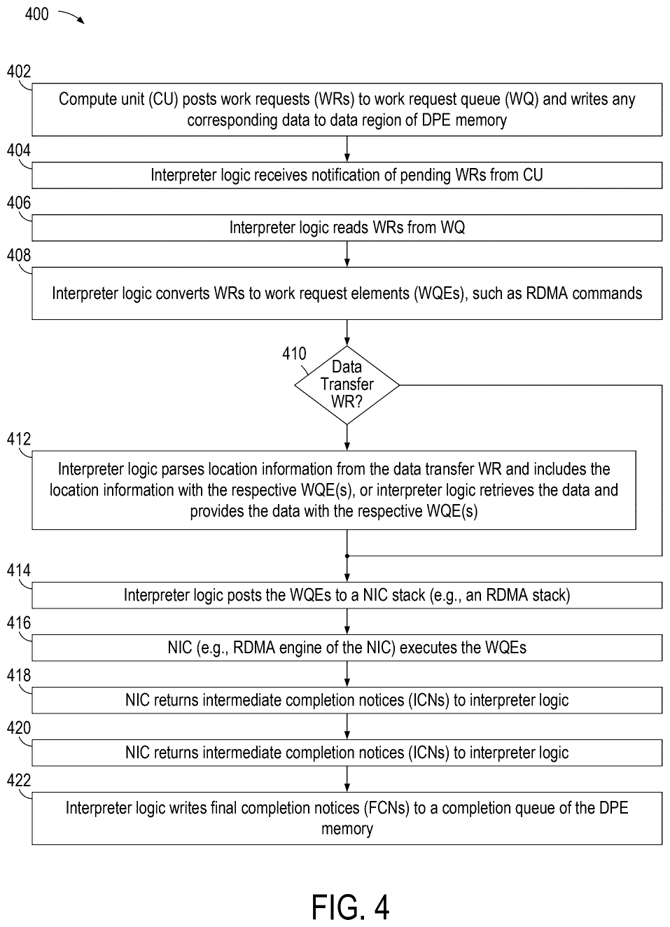

FIG. 3 depicts a system 300 that includes features of system 100, in which interpreter logic 102 is provided within DPE 104, according to an embodiment. In FIG. 3, DPE memory 108 includes a data region 302 and queues 304. Data region 302 may be accessible to NIC 116 (e.g., via DMA engine 132). Data region 302 and/or queues 304 may be accessible to interpreter logic 102 (e.g., via a DMA engine of interpreter logic 102). Queues 304 may include, for example and without limitation, a work request queue (WQ) 306, a control queue 308, and a completion queue (CQ) 310. System 300 is described below with reference to FIG. 4. In an example, CUs 106 share WQ 306, control queue 308, and CQ 310. In another example, one or more of CUs 106 are provided with a dedicated WQ 306, control queue 308, and CQ 310.

FIG. 4 depicts a method 400 of interpreting work requests within a DPE, according to an embodiment. Method 400 is described below with reference to FIG. 3. Method 400 is not, however, limited to the example of FIG. 3.

At 402, a CU 106 posts WRs 120-1 and 120-2 to DPE memory 108. In FIG. 3, CU 106 writes WRs 120-1 and 120-2 to WQ 306. Where WR 120-1 and/or WR 120-2 includes a data transfer opcode, CU 106 writes corresponding data 310-1 and/or data 310-2 to data region 302. CU 106 may include location information regarding data 310-1 and/or data 310-2 (e.g., start/stop offsets within data region 302), within WR 120-1 and/or WR 120-2. CU 106 may also write bookkeeping metadata to control queue 308.

At 404, interpreter logic 102 receives a notification 312 of pending WRs from CU 106. This may be referred to as ringing a doorbell of interpreter logic 102.

At 406, interpreter logic 102 reads WRs 120-1 and 120-2 from WQ 306. Interpreter logic 102 may read metadata of control queue 308 to identify locations of WRs 120-1 and 120-2 within data region 302.

At 408, interpreter logic 102 constructs WQEs 122-1 and 122-2 based on WRs 120-1 and 120-2.

At 410, if WR 120-1 and/or WR 120-2 includes a data transfer WR, processing proceeds to 412, where interpreter logic 102 parses location information regarding data 310-1 and/or data 310-2 from WR 120-1 and/or WR 120-2, and includes the location information within WQE 122-1 and/or WQE 122-2.

At 414, interpreter logic 102 posts WQEs 122-1 and 122-2 to RDMA stack 124 of NIC 116.

At 416, NIC 116 (e.g., RDMA engine 130) executes WQEs 122-1 and 122-2 (e.g., to transfer data 310-1 and 310-2 over network 136).

If WR 120-1 and/or WR 120-2 includes a data transfer operation, NIC 116 (e.g., DMA engine 132 or RDMA engine 130) may read data 310-1 and 310-2 from data region 302 based on location information within WR 120-1 and/or WR 120-2. Alternatively, at 410, data 310-1 and/or data 310-2 may be included within WR 120-1 and/or WR 120-2, or interpreter logic 102 may retrieve data 310-1 and/or data 310-2 from data region 302 based on location information within WR 120-1 and/or WR 120-2, and provide the data to NIC 116 via a dedicated data connection. Interpreter logic 102 may selectively determine whether to provide data 310-1 and/or data 310-2 to NIC 116 via the dedicated connection based on bit-lengths of data 310-1 and data 310-2, and/or based on other criteria. The alternative approach may reduce latency. As an example, if NIC 116 (e.g., DMA engine 132 or RDMA engine 130) retrieves data 310-1 and/or data 310-2 from data region 302 over a PCIe interconnect, each retrieval may consume approximately 1 microsecond, which is approximately how long it takes RDMA engine 130 to transfer 1 kilobyte of data over network 136.

At 418, NIC 116 (e.g., RDMA engine 130) returns ICNs 126-1 and 126-2 to interpreter logic 102.

At 420, interpreter logic 102 writes FCNs 128-1 and 128-2 to CQ 310.

At 422, interpreter logic 102 may notify CU 106 of completion of WRs 120-1 and 120-2.

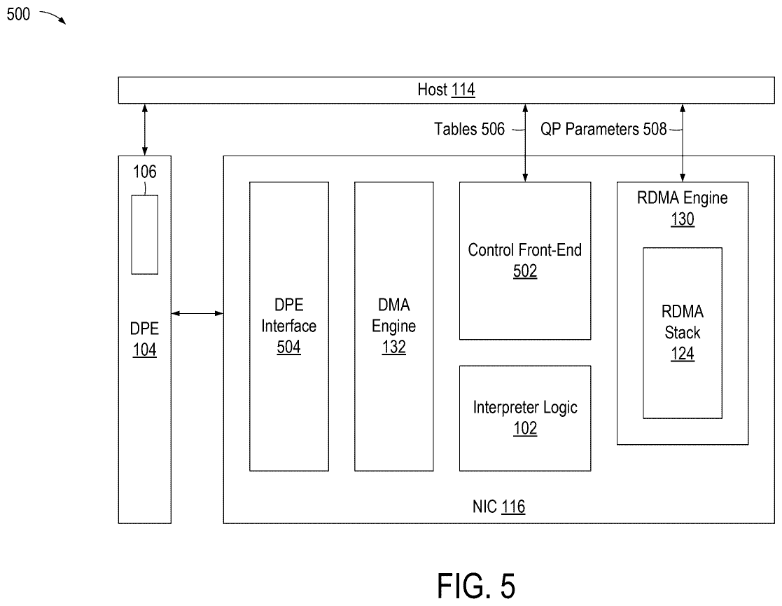

FIG. 5 depicts a system 500 that includes features of system 100, in which interpreter logic 102 is provided within NIC 116, according to an embodiment. In FIG. 5, NIC 116 further includes a control front-end 502 and a DPE interface 504. DPE interface 504 may include a bus interface, such as a PCIe interface. DPE interface 504 is not, however, limited to a PCIe interface.

In an example, CUs 106 write WRs to WQ 306 (FIG. 3), as described further above, and control front-end 502 or DMA engine 132 retrieves the WRs from WQ 306 and provides the WRs to interpreter logic 102. This example may be referred to as a WQ-access mode or configuration. In another example, CUs 106 write WRs to respective register spaces (e.g., memory-mapped registers) of control front-end 502 (e.g., written directly, via respective threads, without a queue), and control front-end 502 provides the WRs to interpreter logic 102. This example may be referred to a memory-mapped input/output (MMIO) mode configuration. In the MMIO mode, CUs 106 may omit maintaining queues (e.g., WQ 306) and associated pointers and other queue control mechanisms. The MMIO mode may reduce latency. In another example, control front-end is configurable to operate in a selectable one of the WQ-access mode and the MMIO mode. In the example of FIG. 5, host 114 may provide parameters to NIC 116, such as tables 506 and/or information for setting up RDMA queue pairs, depicted here as QP parameters 508.

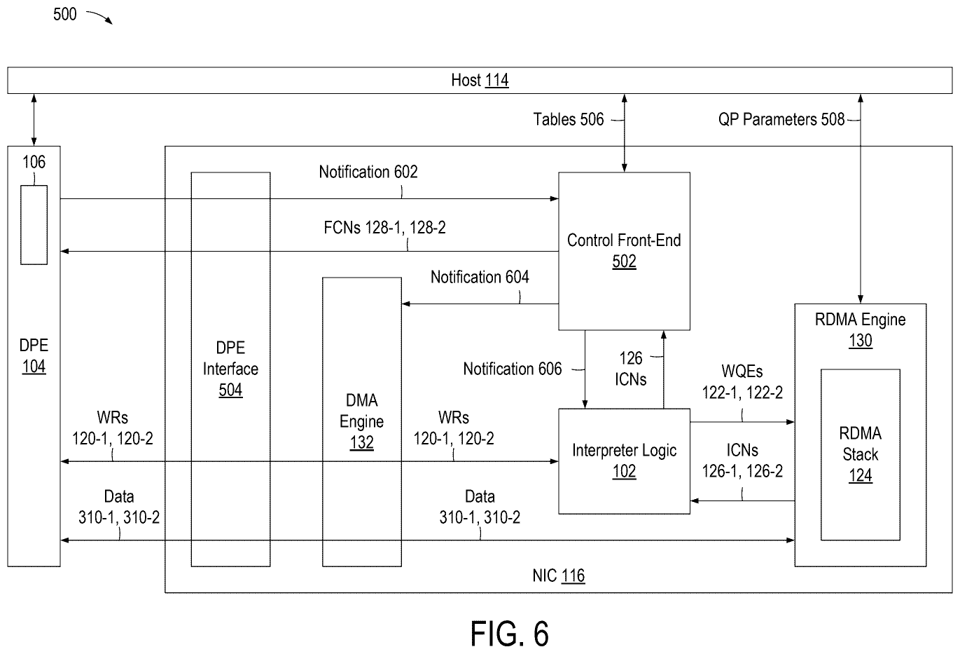

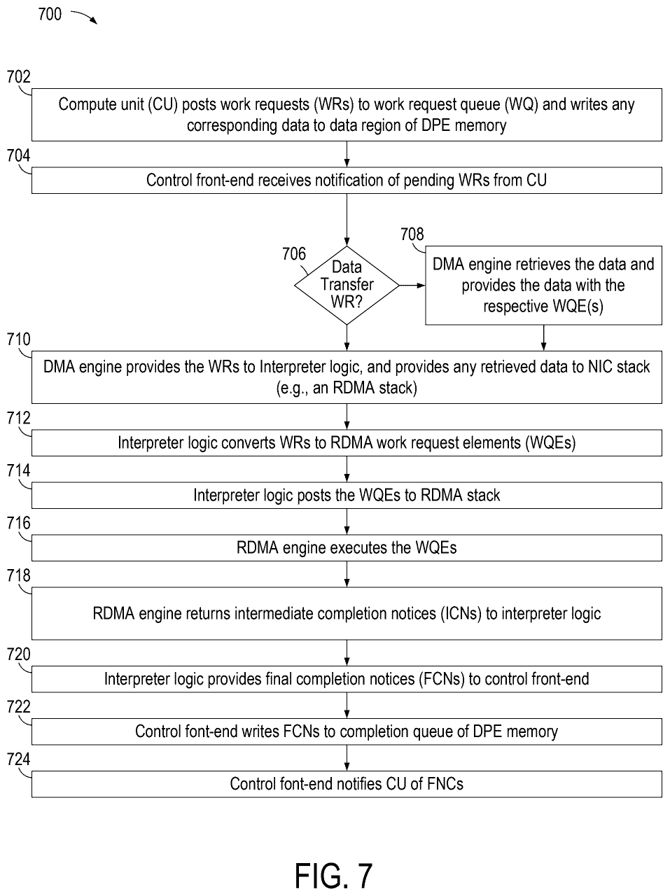

FIG. 6 depicts system 500 in the WQ-access mode, according to an embodiment. FIG. 7 is described below with reference to FIG. 7. FIG. 7 depicts a method 700 of interpreting work requests (WRs) within a network interface controller (NIC), according to an embodiment. Method 700 is described below with reference to FIG. 6. Method 700 is not, however, limited to the example of FIG. 6.

At 702, CU 106 posts WRs 120-1 and 120-2 to DPE memory 108, such as described further above with respect to 402 in FIG. 4.

At 704, control front-end 502 receives a notification 602 of pending WRs from CU 106, and sends a notification 604 to (i.e., rings a doorbell of) DMA engine 132, and a notification 606 to interpreter logic 102. DMA engine 132 may read WRs 120-1 and 120-2 from WQ 306 (FIG. 3), such as described further above with reference to 406 in FIG. 4.

At 706, if WR 120-1 and/or WR 120-2 includes a data transfer WR, processing proceeds to 708, where DMA engine 132 retrieves corresponding data 310-1 and/or data 310-2 from data region 302 of DPE memory 108, based on location information within WR 120-1 and/or WR 120-2.

At 710, DMA engine 132 provides WRs 120-1 and 120-2 to interpreter logic 102, and forwards data 310-1 and/or data 310-2 (as applicable), to RDMA engine 130.

At 712, interpreter logic 102 constructs WQEs 122-1 and 122-2 based on WRs 120-1 and 120-2.

At 714, interpreter logic 102 posts WQEs 122-1 and 122-2 to RDMA stack 124.

At 716, RDMA engine 130 executes WQEs 122-1 and 122-2.

At 718, RDMA engine 130 returns ICNs 126-1 and 126-2 to interpreter logic 102. Interpreter logic 102 may withhold ICNs 126-1 and 126-2 from control front-end 502. Alternatively, interpreter logic 102 may provide ICNs 126-1 and 126-2 to control front-end 502, and control front-end 502 withhold ICNs 126-1 and 126-2 from CU 106.

At 720, interpreter logic 102 provides FCNs 128-1 and 128-2 to control front-end 502.

At 722, control front-end 502 writes FCNs 128-1 and 128-2 to CQ 310 of DPE memory 108.

At 724, control front-end 502 may notify CU 106 of completion of WRs 120-1 and 120-2.

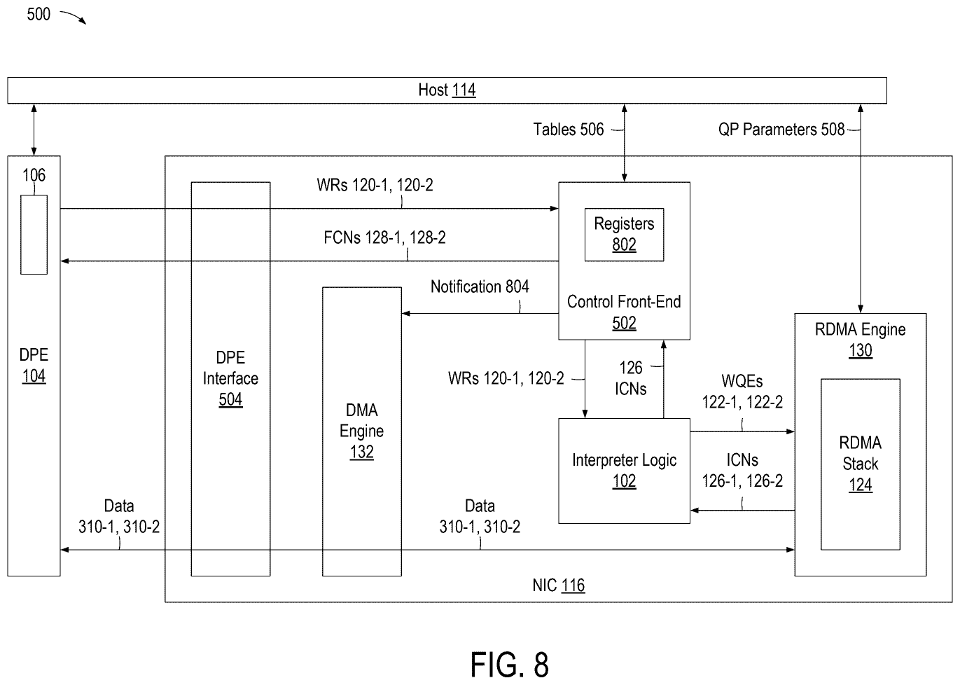

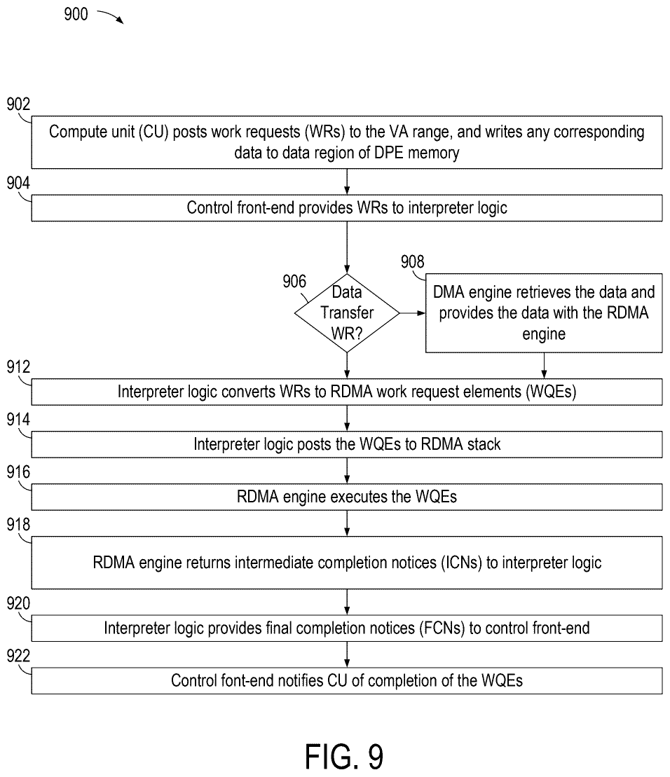

FIG. 8 depicts system 500 in the MMIO configuration, according to an embodiment. In FIG. 8, control front-end 502 includes one or more memory-mapped registers (registers) 802. Addresses of registers 902 may be provided to DPE 104 a priori. FIG. 8 is described below with reference to FIG. 9. FIG. 9 depicts a method 900 of interpreting work requests within a network interface controller (NIC), according to an embodiment. Method 900 is described below with reference to FIG. 8. Method 900 is not, however, limited to the example of FIG. 8.

At 902, CU 106 posts WRs 120-1 and 120-2 to registers 802. If WR 120-1 and/or WR 120-2 includes a data transfer opcode, CU 106 may write corresponding data 310-1 and/or data 310-2 to data region 302 (FIG. 3). CU 106 may include location information regarding data 310-1 and/or data 310-2 (e.g., start/stop offsets within data region 302), within WR 120-1 and/or WR 120-2.

At 904, control front-end 502 provides WRs 120-1 and 120-2 to interpreter logic 102.

At 906, if WR 120-1 and/or WR 120-2 includes a data transfer WR, processing proceeds to 908, where DMA engine 132 retrieves data 310-1 and/or data 310-2 from data region 302 of DPE memory 108, based on location information contained within WR 120-1 and/or WR 120-2, and provides the data to RDMA engine 130.

At 910, interpreter logic 102 constructs WQEs 122-1 and 122-2 based on WRs 120-1 and 120-2.

At 912, interpreter logic 102 posts WQEs 122-1 and 122-2 to RDMA stack 124.

At 914, RDMA engine 130 executes WQEs 122-1 and 122-2.

At 916, RDMA engine 130 returns ICNs 126-1 and 126-2 to interpreter logic 102. Interpreter logic 102 may withhold ICNs 126-1 and 126-2 from control front-end 502. Alternatively, interpreter logic 102 may provide ICNs 126-1 and 126-2 to control front-end 502, and control front-end 502 withhold ICNs 126-1 and 126-2 from CU 106.

At 918, upon completion of WQEs 122-1 and 122-2, interpreter logic 102 provides FCNs 128-1 and 128-2 to control front-end 502.

At 920, control front-end 502 notifies CU 106 of the completion of WQEs 122-1 and 122-2. Control front-end 502 may, for example, provide FCNs 128-1 and 128-2 to CU 106.

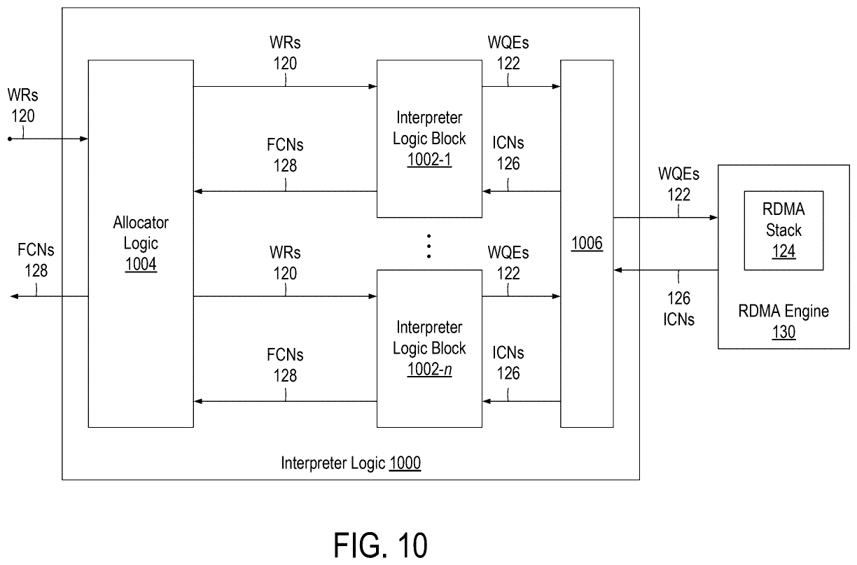

Interpreter logic 102 may be implemented as described below with respect to FIG. 10. Interpreter logic 102 is not, however, limited to the example of FIG. 10.

FIG. 10 depicts interpreter logic 1000, according to an embodiment. Interpreter logic 1000 includes interpreter logic blocks 1002-1 through 1002-n (collectively, interpreter logic blocks 1002), allocator logic 1004 that assigns or sprays WRs 120 to selectable ones of interpreter logic blocks 1002, and interconnects 1006 that multiplex interpreter logic blocks 1002 into one more queues of RDMA engine 130. Interconnects 1006 may provide quality-of-service (QoS), such as by providing higher priority to WQEs of some DPE processes relative to WQEs of other DPE processes.

Interpreter logic 1000 may be useful where multiple CUs 106 simultaneously issue WRs, and/or in other situations/applications. Allocator logic 1004 may assign WRs 120 to interpreter logic blocks 1002 based on current activity/workloads of interpreter logic blocks 1002 and/or other criteria, examples of which are provided below.

Interpreter logic blocks 1002 may serve a WR from start to finish, including waiting for intermediate completion notifications 126 from RDMA engine 130. In an example, one or more interpreter logic blocks 1002 include logic that waits for intermediate completion notifications 126 of multiple WRs 120. This may be useful to permit the interpreter logic blocks 1002 to service other WRs 120. In another example, interpreter logic blocks 1002 delegate waiting for intermediate completion notifications 126 to allocator logic 1004. In another example, interpreter logic 1000 includes dedicated logic that waits for intermediate completion notifications 126 of multiple interpreter logic blocks 1002

The number of interpreter logic blocks 1002 may be selected/determined based on an application. In an example, the number interpreter logic blocks 1002 may be based on a number of simultaneous blocking communication operations expected to be issued by the application (i.e., when all available queue slots for completion notifications are full/utilized, no additional WRs can be processed). In another example, the number interpreter logic blocks 1002 may be based on message sizes utilized by the application (i.e., for smaller message sizes, more WQEs may be issued to saturate the network link).

Interpreter logic blocks 1002 may be identical to one another. Alternatively, one or more interpreter logic blocks 1002 may differ from one or more other interpreter logic blocks 1002. The differences may relate to one or more of a variety of features/characteristics such as, without limitation, latency and/or programmability. As an example, and without limitation, one or more interpreter logic blocks 1002 may be implemented entirely with hardened circuitry (e.g., for reduced latency), and one or more other interpreter logic blocks 1002 may include configurable logic, programmable logic, and/or a processor and memory (e.g., for flexibility, configurability, and/or re-configurability). Where some interpreter logic blocks 1002 differ from other interpreter logic blocks 1002, allocator logic 1004 may assign WRs 120 to interpreter logic blocks 1002 based on the originating CUs 106 (e.g., prioritized CUs), based on a host thread of the WRs (e.g., prioritized CPU threads), and/or features/characteristics of interpreter logic blocks 1002 (e.g., latency versus configurability/programmability).

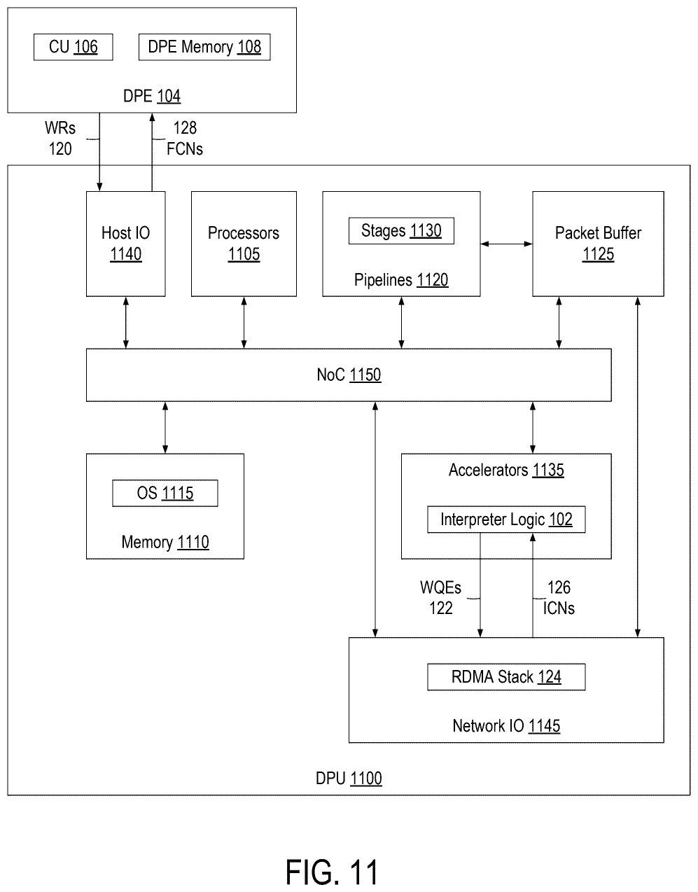

FIG. 11 depicts an integrated circuit device that includes a data processing unit (DPU) 1100, according to an embodiment. In one embodiment, the DPU 1100 is a programmable processor designed to efficiently handle data-centric workloads such as data transfer, reduction, security, compression, analytics, and encryption, at scale in data centers. The DPU 1100 can improve the efficiency and performance of data centers by offloading workloads from a host central processing unit (CPU) or graphic processing units (GPUs). While CPUs and GPUs can specialize on compute, the DPU may specialize in data movement. The DPU 1100 can communicate with host CPUs and GPUs to enhance computing power and the handling of complex data workloads.

The DPU 1100 includes a plurality of processors 1105. In one embodiment, the processors 1105 include any number of processing cores. In one embodiment, the processors 1105 may be CPUs. The processors 1105 can form one or more CPU core complexes. The processors 1105 can be any hardware circuitry that uses an instruction set architecture (ISA) to process data, such as a complex instruction set computer (CISC) or reduced instruction set computer (RISC).

The memory 1110 can include volatile or non-volatile memory such as random access memory (RAM), high bandwidth memory (HBM), and the like. The memory 1110 can include an operating system (OS) 1115 that is separate from the host OS.

In one embodiment, the DPU 1100 may be in (or be used to implement) a network interface controller/card (NIC) such as a SmartNIC that processes packets before they are forwarded to a host (e.g., a host CPU or GPU). In one embodiment, the DPU 1100 is a fully programmable P4 DPU. The DPU 1100 includes multiple pipelines 1120 (which can be the same type or different types) for processing received network packets stored in a packet buffer 1125. In this example, the pipelines 1120 has direct connections to the packet buffer 1125.

The pipelines 1120 can operate in parallel. Further, the pipelines 1120 can be the same type of pipeline (e.g., perform the same tasks). In other embodiments, the DPU 1100 may have different types of pipelines 1120. For example, the DPU 1100 could include networking pipelines which perform networking tasks such as combining packets that were subdivided to be compatible with a maximum transmission unit (MTU) or for dealing with one or more host operating systems, drivers, and/or message descriptor formats in host memory, and could also include direct memory access (DMA) pipelines which perform memory reads and writes.

The pipelines 1120 include multiple stages 1130 where received packet data is processed at each stage 130 before being passed to the next stage. This packet data could be the entire packet or just a portion of the packet. For example, a parser in the DPU 1100, which is upstream from the pipelines 1120, may parse out a particular portion of a received packet (e.g., a packet header vector (PHV)) which is then sent to the one of the pipelines 1120.

The stages 1130 can include circuitry or hardware. In one embodiment, the stages 130 can be programmed using a pipeline programming language, such as P4. In one example, the stages 1130 in one pipeline 1120 perform the same functions of the stages 1130 in another pipeline 1120. However, in other embodiments, the stages may perform different functions.

In addition to the stages, the pipelines 1120 may each include memory, which can be referred to as local memory. This memory can store local tables that indicate how, or if, a particular packet should be processed at the stages 1130. For example, one of the stages in the pipelines 1120 can perform a lookup to read a policing entry in a table to determine whether an entity associated with the packet has exceeded a rate limit (e.g., a packet rate limit, a data rate limit, or both).

The DPU 1100 can include accelerators 1135 to perform specialized tasks associated with data movement. The accelerators 1135 may include a cryptography accelerator, a data compression accelerator, accelerators for performing regex or dedupe, and/or other accelerators.

To communicate with the host and a network, the DPU 1100 includes a host input/output (IO) 1140 and network IO 145. The host IO 1140 can include a PCIe interface, or any suitable protocol for communicated with a CPU or GPU in the host. The network IO 1145 can include Ethernet interfaces, and the like for communicating with a network.

The DPU 1100 includes a network on chip (NoC) 1150 for interconnecting the various components discussed above. While a NoC is disclosed, the DPU 1100 can include any suitable on-chip network. While some components in the DPU 1100 may rely on the NoC 1120 to communicate with other components, the DPU 1100 can also include connections between components that bypass the NoC 1150. For example, the packet buffer 1125 can have a connection to the network IO 1145 that bypasses the NoC 1150. Similarly, the pipelines 1120 can exchange packet data with the packet buffer 1125 without having to rely on the NoC 1150. Similarly, interpreter logic 102 may exchange data (e.g., WQEs 122 and ICNs 126) with network IO 1145 without having to rely on the NoC 1150. However, to transfer data to the processors 1105, the pipelines 120 may use the NoC 1150.

In one embodiment, the DPU 1100 includes security and management features such as offering a hardware root of trust, secure boot, and the like.

In the example of FIG. 11, DPU 1100 receives WRs 120 from DPE 104, and the accelerators 1135 include interpreter logic 102 to process WRs 120, such as described in one or more examples herein. Interpreter logic 102 may exchange WQEs 122 and ICNs 126 with network IO circuitry 1145 via direct connections and/or via NoC 1150. In this example, DPE 104 may serve as a host. Further in the example of FIG. 11, network IO 1145 may include RDMA stack 124. Alternatively, RDMA stack 124 may be maintained in memory 1110.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system, comprising:
interpreter logic configured to:
receive work requests (WRs) from a compute unit (CU);
convert the WRs to remote direct memory access (RDMA) work request elements (WQEs); and
provide the WQEs to an RDMA stack.

2. The system of claim 1, wherein the interpreter logic is further configured to:
receive intermediate completion notices and final completion notices related to the WQEs;
provide the final completion notices to the CU; and
withhold the intermediate completion notices from the CU.

3. The system of claim 1, wherein the interpreter logic is further configured to:
retrieve the WRs from a work queue (WQ) of the CU;
receive intermediate completion notices and final completion notices related to the WQEs; and
write the final completion notices to a completion queue of the CU.

4. The system of claim 3, wherein the interpreter logic is further configured to withhold the intermediate completion notices from the CU.

5. The system of claim 3, wherein:
the WRs comprise a data transfer WR that includes location information indicating a memory location of data for the data transfer WR; and
the interpreter logic is further configured to include the location information in the WQEs of the data transfer WR.

6. The system of claim 3, wherein:
the WRs comprise a data transfer WR that includes location information indicating a memory location of data for the data transfer WR; and
the interpreter logic is further configured to retrieve the data from the memory location based on the location information and to provide the data to a remote direct memory access (RDMA) engine.

7. The system of claim 1, further comprising a network interface controller (NIC) that comprises:
the interpreter logic;
control front-end logic;
a remote direct memory access (RDMA) engine; and
a direct memory access (DMA) engine.

8. The system of claim 7, wherein:
the control front-end logic is configured to receive a notification of pending WRs from the CU;
the DMA engine is configured to retrieve the WRs from a work queue (WQ) of the CU and provide the WRs to the interpreter logic;
the interpreter logic is further configured to receive intermediate completion notices and final completion notices related to the WQEs from the RDMA engine, and to provide at least the final completion notices to the control front-end logic; and
the control front-end logic is further configured to write the final completion notices to a completion queue of the CU.

9. The system of claim 8, wherein one of the interpreter logic and the control front-end logic is further configured to withhold the intermediate completion notices from the CU.

10. The system of claim 8, wherein:
the WRs comprise a data transfer WR, and the data transfer WR comprises location information indicating a memory location of data for the data transfer WR; and
the DMA engine is configured to retrieve the data from the memory location based on the location information in the data transfer WR and provide the data to the RDMA engine.

11. The system of claim 7, wherein:
the control front-end logic comprises a memory-mapped register;
the DPE is further configured to write the WRs to the memory-mapped register;
the control front-end logic is further configured to provide the WRs from the memory-mapped register to the interpreter logic;
the interpreter logic is further configured to receive intermediate completion notices and final completion notices related to the WQEs from the RDMA engine, and to provide at least the final completion notices to the control front-end logic; and
the control front-end logic is further configured to notify the CU of completion of the WRs based on the final completion notices.

12. The system of claim 11, wherein one of the interpreter logic and the control front-end logic is further configured to withhold the intermediate completion notices from the CU.

13. The system of claim 1, wherein the interpreter logic comprises:
multiple interpreter logic blocks;
allocator logic configured to assign the WRs to selectable ones of the interpreter logic blocks; and
interconnects to multiplex the interpreter logic blocks with queues of the RDMA stack.

14. The system of claim 13, wherein:
one or more of the interpreter logic blocks differ from one or more other ones of
the of the interpreter logic blocks with respect to one or more of latency and programmability; and
the allocator logic is further configured to assign the WRs to the interpreter logic blocks based on one or more of CUs from which the WRs originate and characteristics of the interpreter logic blocks.

15. The system of claim 1, wherein the compute unit comprises a compute unit of a graphics processor.

16. A data processing unit (DPU), comprising:
a host interface configured to receive remote direct memory access (RDMA) work requests (WRs) from a host device;
an interpreter accelerator configured to convert the WRs to work request elements (WQEs), and to provide the WQEs to a RDMA stack;
network input/output (IO) circuitry configured to interface with a remote device over a packet-switched network, including to process the WQEs of the RDMA stack;
a packet buffer configured to store packets received by the network IO circuitry;
one or more programmable packet processing pipelines configured to process the packets of the packet buffer;
memory;
one or more processors configured to execute instructions stored in the memory; and
interface circuitry coupled to the host interface, the network IO circuitry, the packet buffer, the packet processing pipeline, the memory, the
processor, and the interpreter accelerator.

17. The DPU of claim 16, wherein the interpreter accelerator is further configured to:
receive intermediate completion notices and final completion notices related to the WQEs;
provide the final completion notices to the host device; and
withhold the intermediate completion notices from the host device.

18. The DPU of claim 16, wherein:
the WRs comprise a data transfer WR that includes location information indicating a memory location of data for the data transfer WR; and
the interpreter logic is further configured to include the location information in the WQEs of the data transfer WR or retrieve the data from the memory based on the location information and provide the data to a remote direct memory access (RDMA) engine.

19. A method, comprising:
receiving work requests (WRs) from a compute unit (CU), by interpreter logic;
converting the WRs to remote direct memory access (RDMA) work request elements (WQEs), by the interpreter logic; and
providing the WQEs to an RDMA stack, by the interpreter logic.

20. The method of claim 19, further comprising:
receiving intermediate completion notices and final completion notices related to the WQEs, by the interpreter logic;
providing the final completion notices to the CU, by the interpreter logic; and
withholding the intermediate completion notices from the CU.
